(19) United States
(12) Patent Application Publication
(10) Pub. No.: US 2018/0065839 A1
(43) Pub. Date: Mar. 8, 2018

(54) AUTOMATED FLUID LEVEL MANAGER

(71) Applicant: Raymond Blake Hogshead, Plymouth, FL (US)

(72) Inventor: Raymond Blake Hogshead, Plymouth, FL (US)

(21) Appl. No.: 15/697,001

(22) Filed: Sep. 6, 2017

Related U.S. Application Data
(60) Provisional application No. 62/384,044, filed on Sep. 6, 2016.

(51) Int. Cl. B67D 3/00

(52) U.S. Cl. CPC B67D 3/0003

(57) ABSTRACT

A fluid level manager may regulate the introduction of a fluid into an environment. The fluid level may include a main housing with at least one entrance hole and at least one exit hole. A pipe may be connected to the first, entrance hole for introducing the fluid into the main housing. Fluid may exit from the main housing into the environment through the exit hole, for instance by gravity. A valve may be provided in the in the main housing in order to automatically shut off the introduction of water into the main housing as fluid accumulates in the housing. One of many embodiments of the environment could be soil, and in this embodiment the housing may be buried in the soil and fluid, which may be water, can be regulated based on soil saturation.

### CROSS REFERENCE TO RELATED APPLICATIONS

This application claims priority to U.S. Provisional Patent Application No. 62/384,044 filed on Sep. 6, 2016, the entire contents of which are herein incorporated by reference.

### FIELD OF THE DISCLOSURE

This disclosure relates generally to fluid regulators and, more particularly, water level managers for use with pots, basins, tanks, or other water-holding containers as well as soil and other porous materials.

### BACKGROUND

Maintaining a steady, ideal amount of fluid is important in a variety of contexts. Controlled marine environments, such as a fish tank or aquarium, require water remain a relatively constant level notwithstanding the frequent circulation of the water, chemicals, nutrients, and so forth. Agricultural containers, such as a photobioreactor or a pot for plants, may also require maintenance of a certain fluid level. Swimming pools and fountains also ideally maintain a level amount of water even though objects are frequently placed in and removed from these fluid containers.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one embodiment of the disclosure, a fluid level manager may be provided for regulating introduction of a fluid into an environment. The fluid level manager may include a main housing including a plurality of walls, a base, a first hole provided in one of the plurality of walls, and an exit hole provided proximate to the base. The fluid level manager may also include a pipe connected with the first hole and a valve provided within the main housing, and the valve may include a valve body provided proximate to the first hole, a valve float having buoyancy allowing it to float on the fluid, and a valve arm connecting the valve body and the valve float. The fluid may be introduced into the main housing through the pipe, and the fluid may be evacuated from the main housing through the exit hole from gravity. The fluid may be retained in the main housing as the environment becomes saturated causing the valve float to rise and the valve body to block the pipe.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIG. 1 illustrates a perspective view of an embodiment of a fluid regulator with internal components shown in phantom;

FIG. 2 illustrates an exploded perspective view of the fluid regulator of FIG. 1;

FIG. 3 illustrates a side, cross-section view across the plane identified in FIG. 1 of an embodiment of a fluid regulator buried in an environment, and the fluid regulator in an open state;

FIG. 4 illustrates a side, cross-section view of the fluid regulator of FIG. 3 in a closed state;

FIG. 5 illustrates a perspective view of an additional embodiment of a fluid regulator; and

FIG. 6 illustrates a side view of the fluid regulator of FIG. 5.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

In one embodiment of the disclosure, a fluid level manager may be provided for regulating introduction of a fluid into an environment. The fluid level manager may include a main housing including a plurality of walls, a base, a first hole provided in one of the plurality of walls, and an exit hole provided proximate to the base. The fluid level manager may also include a pipe connected with the first hole and a valve provided within the main housing, and the valve may include a valve body provided proximate to the first hole, a valve float having buoyancy allowing it to float on the fluid, and a valve arm connecting the valve body and the valve float. The fluid may be introduced into the main housing through the pipe, and the fluid may be evacuated from the main housing through the exit hole from gravity. The fluid may be retained in the main housing as the environment becomes saturated causing the valve float to rise and the valve body to block the pipe.

Further embodiments of a fluid level manager may include an adjustment nut between the valve body and the valve arm in order to adjust the angle between the valve body and the valve arm. The main housing may include a second hole provided in one of the plurality of walls, and air form the environment may be passable through the second hole. The fluid level manager may include a hose connected with the second hole, and air from the environment may be passable through the hose. The first hole may be proximate to the second hole, and the hose and pipe may be collectively secured with at least one strap. The fluid level manager may include a secondary container containing the environment. The environment may be soil and the fluid may include water.

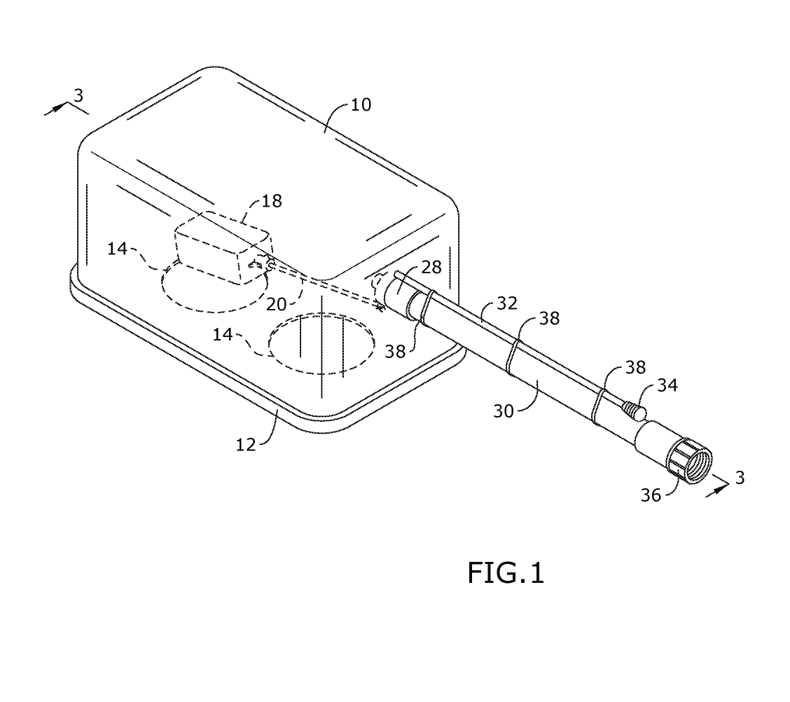

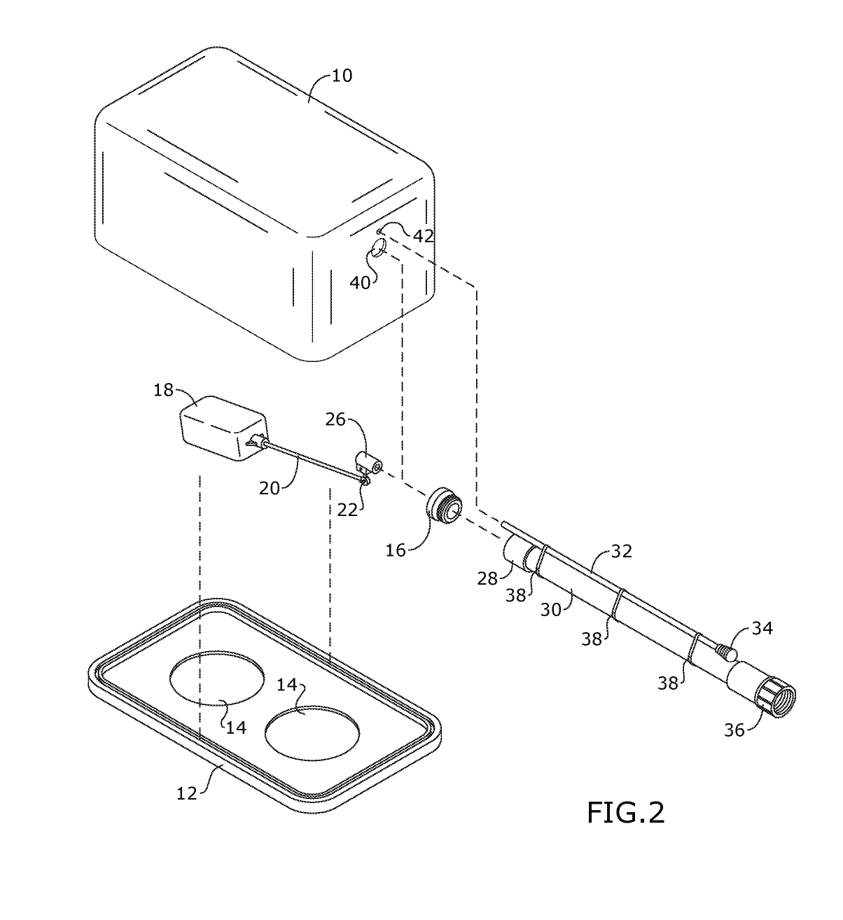

With reference to FIGS. 1 and 2, a fluid regulator for regulating or controlling the release of a fluid into an environment may include a main housing 10, a first pipe 30 leading into main housing 10 through a first hole 40 on main housing 10, and one or more exit holes or slits 14 provided on main housing 10. A base 12 may be provided as a wall of housing 10, and in some embodiments base 12 may be a removable lid provided on housing 10 so as to permit access to, and maintenance of, internal components of the fluid regulator. In the illustrated embodiment, exit holes 14 are integrated into the lid, however it should be understood that lid holes 14 may be provided in a wall of main housing 10. Exit holes 14 are shown in the illustrated embodiment as two, circular holes, however it should be understood other shapes and dimensions for exit holes 14 are contemplated particularly in order to regulate flow rate out of the main housing 10. Variable sized exit holes 14 are also contemplated. A second hole 42 is also contemplated and may be provided proximate to first hole 40, as shown in the illustrated embodiment, or alternatively may be provided on housing 10 at a significant distance from first hole 40, including for instance on a separate wall of housing 10. A hose 32 may be provided through second hole 42. In embodiments where first and second holes 40, 42 are provided proximate to each other, pipe 30 and hose 32 may be secured to one another, for increased stability, by one or more straps 38 collectively wrapped around pipe 30 and hose 32.

One end of pipe 30 may be connected with, or inserted through, first hole 40. In the illustrated embodiment, a wall fitting 16 is provided within first hole 40 and is connectable with an end of pipe 30, for instance by matable threading between wall fitting 16 and a feed pipe connector 28 provided on pipe 30. A fluid, such as water, may be provided through pipe 30 at an opposing end of pipe 30. In some embodiments, a hose connector 36 may be provided on the opposing end of pipe 30 so as to connect pipe 30 with a fluid source, such as a garden hose. One end of hose 32 may connectable with, or possibly insertable through, second hole 42. An opposing end of hose 32 may be open so as to permit air to freely enter or escape hose 32. A filter 34 may be provided on the opposing end of hose 32 so as to restrict particulates or debris from unintentionally entering main housing 10 through hose 32.

A float valve may be provided in order to regulate the introduction of fluid into main housing 10. The float valve may include a float 18, a valve body 26, and a float arm 20 connecting the float 18 and valve body 26. An adjustment nut 22 may also be provided proximate to valve body 26.

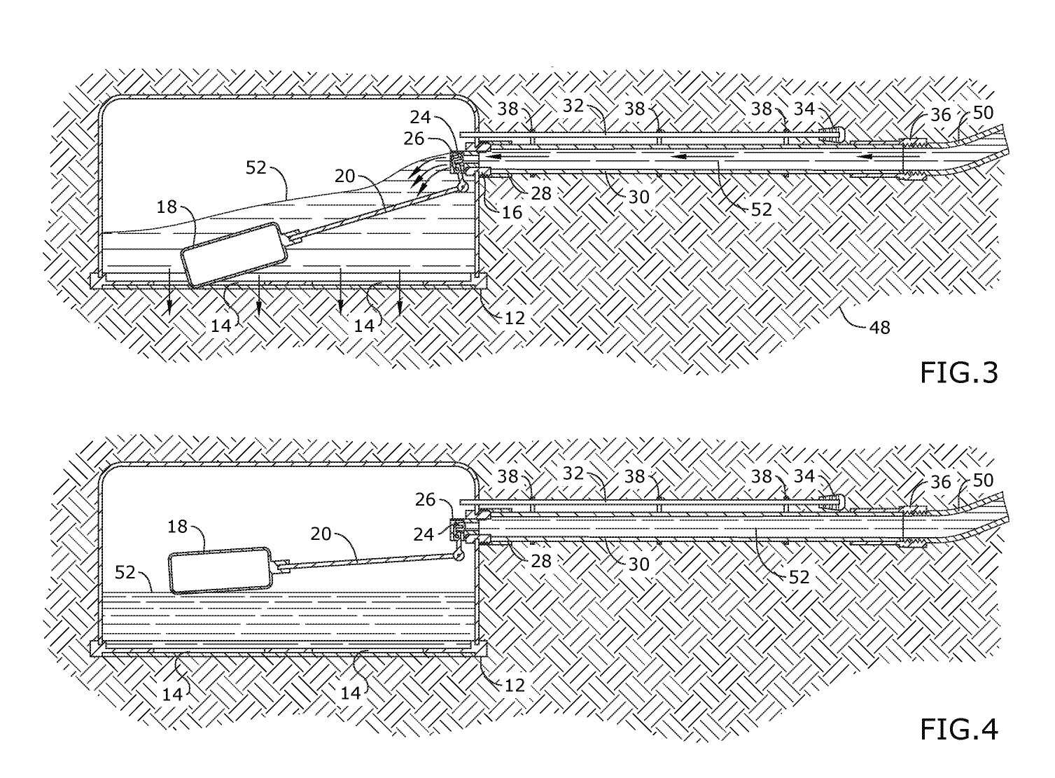

With reference now to FIGS. 3 and 4, a fluid 52 may be introduced into main housing 10 through pipe 30. Fluid 52 may eminent from a fluid source 50, such as a supply hose connected with hose connector 36 as shown in the illustrated embodiment. Fluid 52 may pass into main housing 10, and exit main housing 10 through exit holes 14. In some embodiments, exit holes 14 may be provided on the bottom of housing 10 so as to permit gravity to force fluid 52 out of main housing 10 into a surrounding environment 48. In the illustrated embodiment, the surrounding environment 48 may be porous material, such as soil, requiring irrigation. Fluid 52 may then be applied to environment 48 through main housing 10. As environment 48 becomes saturated, fluid 52 would become unable to exit main housing 10. With fluid 52 no longer exiting housing 10, float 18 would rise and cause valve body 26 to angle towards the opening of hose 30. A stopper 24 may be provided on valve body 26, and as float 18 rose stopper 24 would become aligned with, and ultimately inserted into, pipe 30 resulting in a slow and eventual cessation of fluid 52 flow. As saturation of environment 48 is reduced, fluid 52 may again flow through exit holes 14 causing float 18 to lower and stopper 24 to be removed from pipe 30 thereby permitting fluid 52 to once again flow into main housing 10. Air flow through hose 32 would facilitate pressure equalization encouraging smooth fluid 52 flow. Adjustment nut 22 may be utilized to adjust the angle of valve body 26 with respect to valve arm 22, which would result in adjusting the height of float 20 required to result in stopper 24 stopping the flow of fluid 52 through pipe 30. With this component, the amount of fluid 52 required to be retained within housing 10 in order to shut off the flow of fluid 52 through pipe 30 becomes adjustable.

As shown in the illustrated embodiment, the entirety or at least a portion of embodiments of a fluid regulator may be submerged in the environment 48 to be provided fluid 52. In one embodiment, this may mean burying main housing 10 in soil 48 to be kept a constant saturation of water 52. Other environments 48 may include fountains, swimming pools, aquariums, bioreactors, and any other environments known or to be developed which would require regular introduction of a fluid 52. Similarly, fluid 52 may be any known or to be developed fluid 52 which would require regular introduction into a known or to be developed environment 48. Examples may include water, chemical treatment, or nutritional supplements.

In the illustrated embodiment, exit holes 14 are provided at the lowest point of housing 10, such as base or lid 12, so as to permit gravity to urge evacuation of fluid 52 into environment 48. Exit holes 14 could also be provided proximate, but not necessarily at, a lower end of housing 10 such as on a lower end of a side wall of housing 10. A pumping system (not illustrated) is further contemplated for evacuation of fluid 52 from housing 10. In this regard, exit holes 14 would not necessarily need to be placed at or towards the bottom of housing 10. The pumping system could be provided in fluid communication with fluid 52, either within housing 10 or with an exit pipe (not illustrated) provided at exit holes 14. Embodiments of the fluid regulation system may be a closed system in that pipe 30, main housing 10, and environment 48 are all interconnected thereby circulating fluid 52 between each.

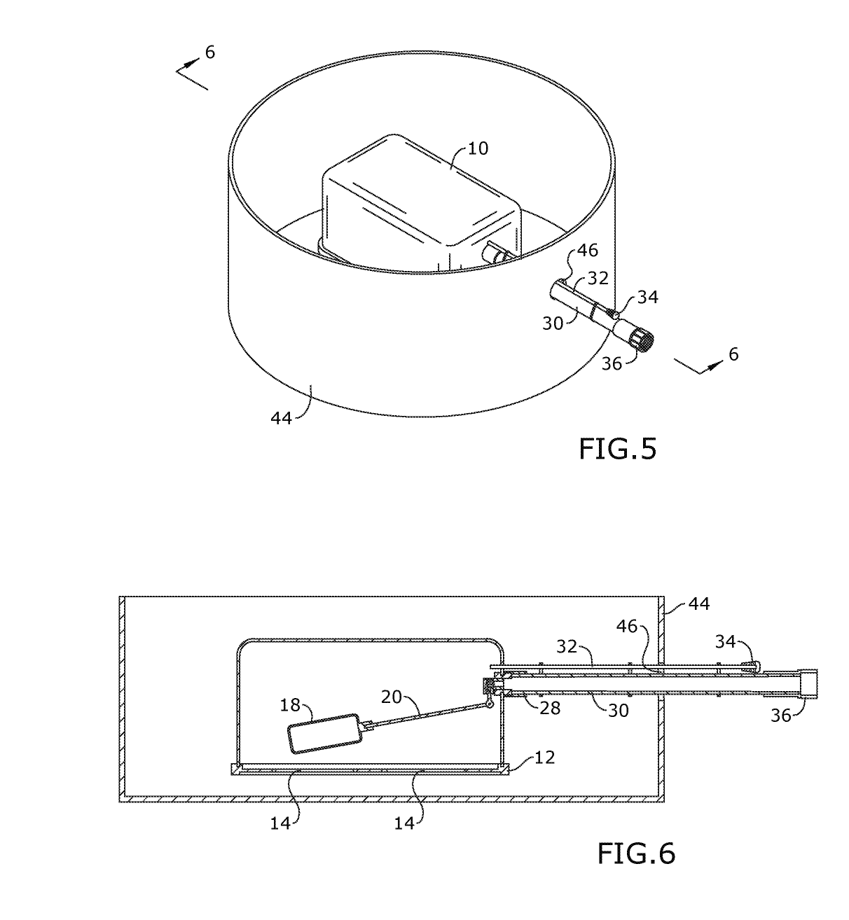

FIGS. 5 and 6 illustrate embodiments of the fluid regulation system including a secondary container 44 surrounding main housing 10. In such an embodiment, environment 48 may be confined to within secondary container 44. A secondary container hole 46 may be provided in a wall of secondary container 46 in order to permit passage of pipe 30, hose 32, or both as illustrated.

Embodiments of a fluid regulation system may be utilized in a method for maintaining a fluid saturation level of an environment. One such example is for keeping soil sufficiently moist. A pot may be provided as secondary container 46 and filled with soil. Another example may be an aquarium in order to maintain a water level despite loss of water due to spillage, evaporation, or another cause.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

What is claimed:

1. A fluid level manager for regulating introduction of a fluid into an environment, the fluid level manager comprising:
a main housing including a plurality of walls, a base, a first hole provided in one of the plurality of walls, and an exit hole provided proximate to the base;
a pipe connected with the first hole; and
a valve provided within the main housing, the valve including
a valve body provided proximate to the first hole,
a valve float having buoyancy allowing it to float on the fluid, and
a valve arm connecting the valve body and the valve float,
wherein the fluid is introduced into the main housing through the pipe, and the fluid is evacuated from the main housing through the exit hole from gravity; and
wherein fluid is retained in the main housing as the environment becomes saturated causing the valve float to rise and the valve body to block the pipe.

2. The fluid level manager of claim 1, further comprising an adjustment nut between the valve body and the valve arm in order to adjust the angle between the valve body and the valve arm.

3. The fluid level manager of claim 1, wherein the main housing further includes a second hole provided in one of the plurality of walls, and air from the environment is passable through the second hole.

4. The fluid level manager of claim 3 further comprising a hose connected with the second hole, and air from the environment is passable through the hose.

5. The fluid level manager of claim 4 wherein the first hole is proximate to the second hole, and the hose and pipe are collectively secured with at least one strap.

6. The fluid level manager of claim 1, wherein the main housing is surrounded by the environment.

7. The fluid level manager of claim 6, further comprising a secondary container containing the environment.

8. The fluid level manager of claim 7, wherein the environment is soil and the fluid comprises water.
